(19) United States
(12) Patent Application Publication
(10) Pub. No.: US 2015/0177143 A1
(43) Pub. Date: Jun. 25, 2015

(54) PARTICLE DETECTION DEVICE

(71) Applicant: Sharp Kabushiki Kaisha, Osaka-shi, Osaka (JP)

(72) Inventors: Hideaki Fujita, Osaka-shi (JP); Tomonori Kamo, Osaka-shi (JP); Akihiro Suzuki, Osaka-shi (JP); Haruki Kamiyama, Osaka-shi (JP); Kazuya Kitamura, Osaka-shi (JP)

(21) Appl. No.: 14/415,767

(22) PCT Filed: Jul. 30, 2013
(86) PCT No.: PCT/JP2013/070574

§ 371 Date: Jan. 20, 2015

(30) Foreign Application Priority Data
Aug. 30, 2012 (JP) 2012-190043

(51) Int. Cl. G01N 21/64

(52) U.S. Cl. CPC G01N 21/64

(57) ABSTRACT

A particle detection device detects a biological particle. The particle detection device includes a collection sheet, a collection unit, a heating unit, a fluorescence detection unit, and a movement mechanism. The collection unit introduces an airborne particle into the device so that the airborne particle is collected on the collection sheet. The heating unit heats the particle collected on the collection sheet so as to increase fluorescence emitted from the particle. The fluorescence detection unit detects the fluorescence emitted from the particle which is collected on the collection sheet. The movement mechanism moves the collection sheet. With the configuration as described above, the particle detection device with which a measurement time period and the cost of measurement can be reduced can be provided.

### TECHNICAL FIELD

The present invention generally relates to a particle detection device, and particularly relates to a particle detection device that detects biological particles.

### BACKGROUND ART

Regarding related-art particle detection devices, for example, a method of detecting airborne microorganisms is disclosed in Japanese Unexamined Patent Application Publication No. 2007-135476 (PTL 1). In this method, simple sampling of airborne microorganisms is performed in order to count the number of the microorganisms.

The method of detecting airborne microorganisms disclosed in PTL 1 includes the following steps: that is, a step in which microorganisms in the atmosphere are collected on an adhesive sheet; a step in which a microorganisms collection surface of the adhesive sheet is brought into contact with a culture medium surface so as to cause fissiparity of the microorganisms to occur, and a step in which the microorganisms having been reproduced by fissiparity are observed and counted through the adhesive sheet.

Furthermore, a measurement device for suspended particulate matter is disclosed in Japanese Unexamined Patent Application Publication No. 2002-357532. An object of the measurement device for suspended particulate matter is to simultaneously measure the densities of suspended particulate matter and pollen in the atmosphere (PTL 2).

The measurement device disclosed in PTL 2 includes the following components: that is, a suspended particulate matter collection unit that causes suspended particulate matter in a sample gas to be collected on filter paper; a suspended particulate matter detection unit that irradiates the suspended particulate matter on the filter paper with β-rays and detects the amount of transmitted β-ray so as to detect the suspended particulate matter; and a pollen detection unit that irradiates the pollen contained in the suspended particulate matter with ultraviolet rays and detects the intensity of generated fluorescence so as to detect the amount of the pollen.

### CITATION LIST

### Patent Literature

PTL 1: Japanese Unexamined Patent Application Publication No. 2007-135476
PTL 2: Japanese Unexamined Patent Application Publication No. 2002-357532

### SUMMARY OF INVENTION

### Technical Problem

According to the method of detecting airborne microorganisms disclosed in PTL 1, for example, the number of colonies of the microorganisms is measured by collecting the airborne microorganisms on the adhesive sheet with an air sampler and culturing the collected microorganisms (for one to seven days). However, the detection method utilizing culturing of microorganisms as described above requires a very long time period for obtaining measurement results and increases the cost of the measurement.

Accordingly, an object of the present invention is to address the above-described problems, that is, to provide a particle detection device with which the measurement time period can be reduced and the cost of measurement can be reduced.

### Solution to Problem

A particle detection device according to the present invention detects a biological particle. The particle detection device includes a sheet-shaped member, a collection unit, a heating unit, a fluorescence detection unit, and a movement mechanism. The collection unit introduces an airborne particle into the device so that the airborne particle is collected on the sheet-shaped member. The heating unit heats the particle collected on the sheet-shaped member so as to increase fluorescence emitted from the particle. The fluorescence detection unit detects the fluorescence emitted from the particle which is collected on the sheet-shaped member. The movement mechanism moves the sheet-shaped member.

With the particle detection device structured as described above, the sheet-shaped member having low heat capacity is used so that the airborne particle is collected. Thus, a time period for heating the particle performed by the heating unit can be reduced, and energy consumed by the heating unit can be reduced. Thus, the particle detection device with which a measurement time period and the cost of measurement can be reduced can be realized.

Furthermore, the sheet-shaped member preferably includes an adhesive surface. In this case, the collection unit blows the airborne particle having been introduced into the device to the sheet-shaped member so that the particle is collected on the adhesive surface. With the particle detection device structured as described above, the particle can be collected by a further simplified device structure.

Furthermore, the movement mechanism preferably moves the sheet-shaped member between a first position, at which the particle is collected on the sheet-shaped member by the collection unit, a second position, at which the particle is heated by the heating unit, and a third position, at which the fluorescence is detected by the fluorescence detection unit. With the particle detection device structured as described above, the sheet-shaped member can be freely moved between a particle collection step performed by the collection unit, a particle heating step performed by the heating unit, and a fluorescence detection step performed by the fluorescence detection unit.

Furthermore, the sheet-shaped member preferably continuously extends in a sheet shape through the first position, at which the particle is collected on the sheet-shaped member by the collection unit, the second position, at which the particle is heated by the heating unit, and the third position, at which the fluorescence is detected by the fluorescence detection unit. With the particle detection device structured as described above, a plurality of steps from among the particle collection step performed by the collection unit, the particle heating step performed by the heating unit, and the fluorescence detection step performed by the fluorescence detection unit can be performed in parallel with one another.

Furthermore, the heating unit preferably includes a light source that emits light toward the particle. With the particle detection device structured as described above, a time period to heat the particle can be further reduced by irradiating the particle with the light emitted from the light source.

Furthermore, the movement mechanism preferably includes a sheet supply unit that supplies the sheet-shaped member to the collection unit and a sheet reception unit that collects the sheet-shaped member from the fluorescence detection unit. With the particle detection device structured as described above, the sheet-shaped member is supplied from the sheet supply unit to the collection unit while the sheet-shaped member is collected from the fluorescence detection unit to the sheet reception unit. Thus, particle measurement can be continuously performed.

Furthermore, the particle detection device preferably further includes a housing that contains the sheet-shaped member wound into a roll and that is detachably attached to the device. With the particle detection device structured as described above, the particle measurement can be continuously performed by periodically replacing the housing.

Furthermore, the particle detection device preferably detects the biological particle from a difference between an amount of the fluorescence detected from the particle before the particle is heated by the heating unit and an amount of the fluorescence detected from the particle after the particle has been heated by the heating unit. With the particle detection device structured as described above, measurement errors ascribable to particles other than the biological particle can be reduced, and accordingly, the biological particle can be highly precisely detected.

### Advantageous Effects of Invention

As has been described above, according to the present invention, the particle detection device with which the measurement time period and the cost of measurement can be reduced can be provided.

### BRIEF DESCRIPTION OF DRAWINGS

FIG. 1 includes graphs illustrating a change in fluorescent intensity of biological particles before and after heating and a change in fluorescent intensity of dust before and after heating.

FIG. 2 is a graph illustrating the relationship between an increase ΔF in fluorescent intensity before and after heating and the concentration of biological particles.

FIG. 3 is a side view illustrating a particle detection device according to an embodiment of the present invention.

FIG. 4 is an enlarged side view illustrating a region surrounded by a two-dot chain line IV in FIG. 3.

FIG. 5 is a side view illustrating a collection unit provided in the particle detection device illustrated in FIG. 3.

FIG. 6 is a side view illustrating a variant of the collection unit illustrated in FIG. 5.

FIG. 7 is a side view illustrating a heating unit provided in the particle detection device illustrated in FIG. 3.

FIG. 8 is a side view illustrating a first variant of the heating unit illustrated in FIG. 7.

FIG. 9 is a side view illustrating a second variant of the heating unit illustrated in FIG. 7.

FIG. 10 is a perspective view illustrating a fluorescence detection unit provided in the particle detection device illustrated in FIG. 3.

FIG. 11 is a perspective view for describing a method of replacing a collection sheet illustrated in FIG. 3.

FIG. 12 is a flowchart illustrating a flow of operations of the particle detection device illustrated in FIG. 3.

### DESCRIPTION OF EMBODIMENTS

An embodiment of the present invention will be described with reference to the drawings. The same or corresponding elements are denoted by the same reference signs in the drawings referred to in the following description.

A particle detection device according to the present embodiment detects biological particles such as pollen, microorganisms, and molds. The principle of detecting biological particles using the particle detection device according to the present embodiment is initially described.

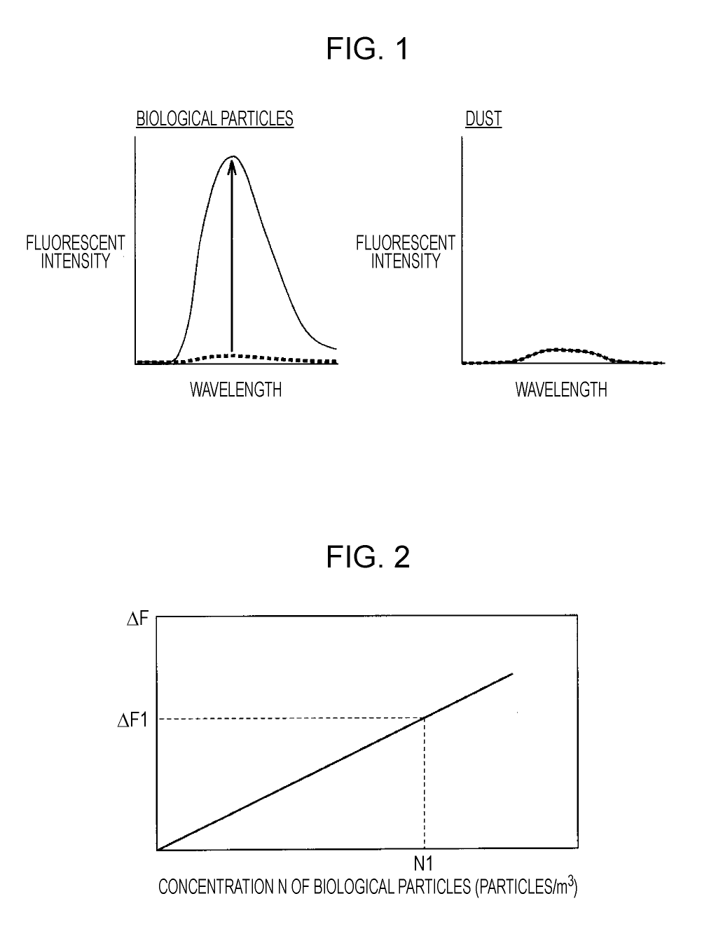

FIG. 1 includes graphs illustrating a change in fluorescent intensity of biological particles before and after heating and a change in fluorescent intensity of dust before and after heating.

Airborne biological particles emit fluorescence when being irradiated with ultraviolet light or blue light. In air, however, other particles such as lint of chemical fiber (also referred to as dust hereafter), which emit fluorescence similarly to biological particles, are also suspended. Thus, only by detecting fluorescence, it is impossible to distinguish whether the fluorescence comes from biological particles or dust.

When, as illustrated in FIG. 1, biological particles and dust are heated and changes in the fluorescent intensities (amount of fluorescence) thereof are measured before and after heating, the fluorescent intensity emitted from the dust is not changed by heating and the fluorescent intensity emitted from the biological particles is increased by heating. The particle detection device according to the present embodiment measures the fluorescent intensity of mixed particles of biological particles and dust before and after heating, and obtains the difference between the fluorescent intensity before and after the heating, thereby determining the number of the biological particles.

FIG. 2 is a graph illustrating the relationship between an increase ΔF in the fluorescent intensity before and after heating and the concentration of biological particles.

Referring to FIG. 2, an increase ΔF1 in the fluorescent intensity is specifically calculated from the difference in the fluorescent intensity before and after heating. A concentration N1 of biological particles corresponding to the calculated increase ΔF1 is found in accordance with a prepared relationship between the increase ΔF in the fluorescent intensity and the concentration N of biological particles. The correspondence relationship between the increase ΔF and the concentration N of biological particles is experimentally predetermined.

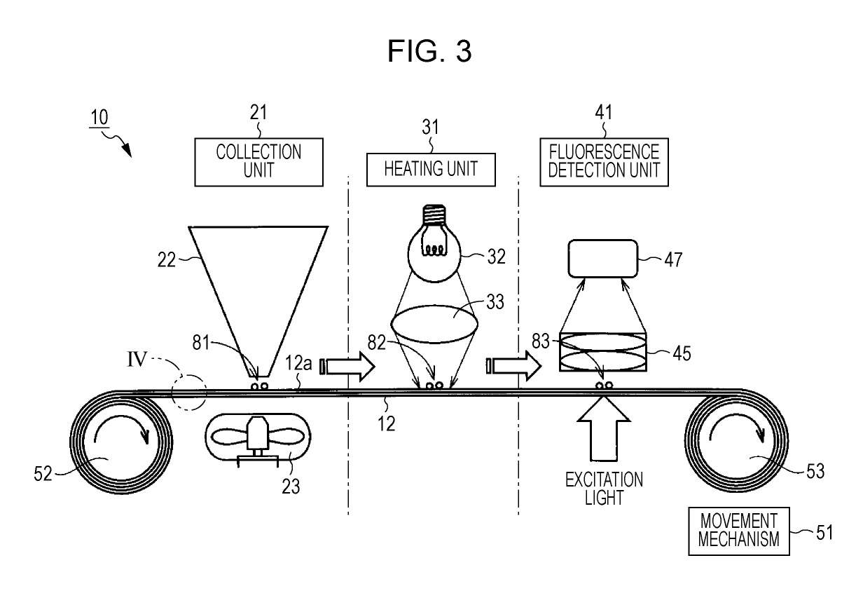

Next, the structure of the particle detection device according to the present embodiment is described. FIG. 3 is a side view of the particle detection device according to the embodiment of the present invention.

Referring to FIG. 3, a particle detection device 10 according to the present embodiment includes a collection sheet 12, a collection unit 21, a heating unit 31, and a fluorescence detection unit 41.

The collection unit 21, the heating unit 31, and the fluorescence detection unit 41 are spaced apart from one another. The collection unit 21, the heating unit 31, and the fluorescence detection unit 41 are linearly arranged. In this linear arrangement, the heating unit 31 is located between the collection unit 21 and the fluorescence detection unit 41. The collection unit 21 is disposed adjacent to a sheet supply drum 52, and the fluorescence detection unit 41 is disposed adjacent to a sheet reception drum 53. The sheet supply drum 52 and the sheet reception drum 53 will be described later.

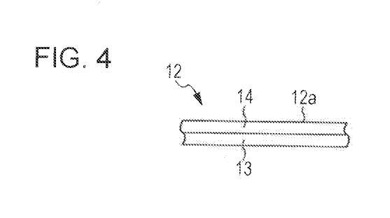

FIG. 4 is an enlarged side view illustrating a region surrounded by a two-dot chain line IV in FIG. 3. Referring to FIGS. 3 and 4, the collection sheet 12 on which biological particles are collected uses a sheet-shaped member. In the present embodiment, mixed particles of biological particles and dust such as lint of chemical fiber are collected on the collection sheet 12.

The collection sheet 12 is formed to have a sheet shape that has a specified width and extends in a single direction. The collection sheet 12 has a thin plate shape. The collection sheet 12 has a degree of flexibility so that the collection sheet 12 can be wound around the sheet supply drum 52 and the sheet reception drum 53, which will be described later.

The collection sheet 12 has a sheet shape that continuously extends through the following positions: that is, a collection position 81 serving as a first position at which particles are collected on the collection sheet 12 by the collection unit 21; a heating/cooling position 82 serving as a second position at which the heating unit 31 heats the particles; and a fluorescence detection position 83 serving as a third position at which the fluorescence detection unit 41 detects fluorescence emitted from the particles. The collection sheet 12 has a length greater than the distance between the collection position 81 and the fluorescence detection position 83.

The collection sheet 12 has an adhesive surface 12a that holds the collected particles. The adhesive surface 12a has adhesive properties. In the present embodiment, the adhesive surface 12a has a sheet shape continuously extends in the same single direction as that of the collection sheet 12.

The collection sheet 12 includes a base material 13 and an adhesive 14. The base material 13 has a sheet shape that has a specified width and extends in a single direction. The adhesive 14 is provided on one of the surfaces of the base material 13. The adhesive surface 12a of the collection sheet 12 that holds the collected particles is formed by the surface of the adhesive 14.

With the structure as described above, the particles are attracted to the adhesive surface 12a. Thus, the particles can be collected with a simple structure. Furthermore, the particles can be moved between the collection position 81, the heating/cooling position 82, and the fluorescence detection position 83 while being held by the adhesive surface 12a in a further stable manner.

The base material 13 preferably uses a material that has a high thermal resistance and an appropriate strength. More specifically, the base material 13 preferably uses a resin material having a high thermal resistance, for example, polyimide. Alternatively, the base material 13 may use glass or one of a variety of metal sheets (for example, a copper sheet). When the base material 13 has a high thermal conductivity than that of the adhesive 14, the thickness of the base material 13 is preferably greater than that of the adhesive 14.

The adhesive 14 preferably uses an acrylic or silicone based adhesive.

The adhesive 14 may be arranged on the base material 13 in the pitch equal to or substantially equal to the pitch of the collection position 81, the heating/cooling position 82, and the fluorescence detection position 83. In this case, the cost of the collection sheet 12 can be reduced and the particles can be prevented from being attracted to undesired portions of the collection sheet 12.

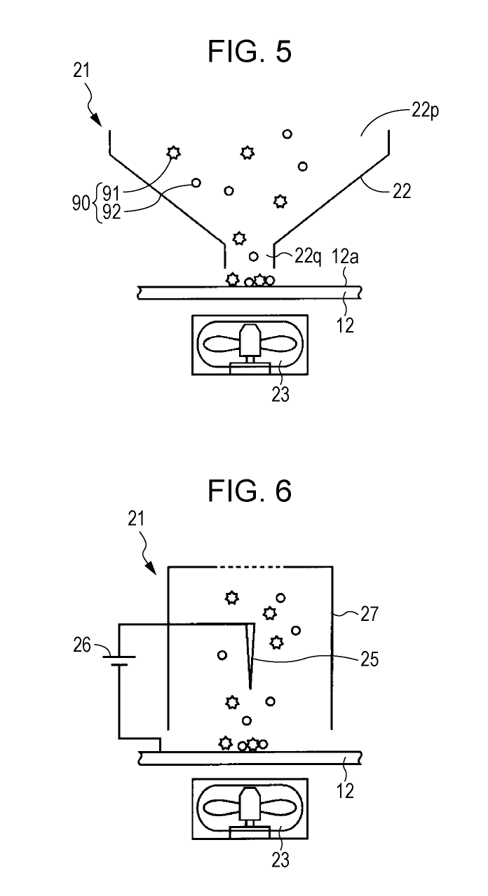

FIG. 5 is a side view illustrating the collection unit provided in the particle detection device illustrated in FIG. 3. Referring to FIG. 5, the collection unit 21 introduces airborne particles into the device so that the particles are collected on the collection sheet 12.

The collection unit 21 includes a collection barrel 22 and a fan 23. The fan 23 generates an air flow that causes the air to be taken into the device and to be blown toward the collection sheet 12. The collection barrel 22 guides the air which has been taken into the device by driving the fan 23 to the collection sheet 12.

The collection barrel 22 includes a suction portion 22p and a discharge portion 22q. The collection barrel 22 has a barrel shape. The collection barrel 22 has a barrel shape in which the suction portion 22p and the discharge portion 22q of the collection barrel 22 are open ends. The diameter of the collection barrel 22 is large in the suction portion 22p and small in the discharge portion 22q. The diameter of the collection barrel 22 decreases from the suction portion 22p toward the discharge portion 22q. The collection barrel 22 is positioned so that the discharge portion 22q faces the adhesive surface 12a of the collection sheet 12. The fan 23 is disposed on a side of the collection sheet 12 opposite to the collection barrel 22 with the collection sheet 12 interposed therebetween.

During the collection step performed by the collection unit 21, airborne particles 90 are sucked into the collection barrel 22 through the suction portion 22p due to driving of the fan 23. The particles 90 include biological particles 91 and dust 92 (inorganic foreign matter) such as lint of chemical fiber. The speed at which the particles 90 are sucked into the collection barrel 22 increases as the particles 90 approach the tapered discharge portion 22q from the suction portion 22p, and the particles 90 are blown to the adhesive surface 12a of the collection sheet 12 through the discharge portion 22q. The particles 90 are held by the adhesive surface 12a having adhesive properties, thereby being collected on the collection sheet 12.

The particles 90 may be collected with an air sampler device that can be used for collection in a culturing method.

FIG. 6 is a side view illustrating a variant of the collection unit illustrated in FIG. 5. Referring to FIG. 6, a collection barrel 27 is provided instead of the collection barrel 22 illustrated in FIG. 5, and an electrostatic stylus 25 serving as a discharge electrode and a high-voltage power source 26 serving as a power unit are provided in the present variant. The air that contains the particles is guided toward the collection sheet 12, which is positioned so as to face the electrostatic stylus 25, through the collection barrel 27. The high-voltage power source 26 is provided as the power unit to generate a potential difference between the collection sheet 12 and the electrostatic stylus 25.

In the present variant, the collection sheet 12 is formed of glass. An electrically conductive transparent film is formed on a surface of the glass.

The electrostatic stylus 25 extends from the high-voltage power source 26, penetrates through a wall portion of the collection barrel 27, and reaches the inside of the collection barrel 27. The electrostatic stylus 25 faces the surface of the collection sheet 12. In the present embodiment, the electrostatic stylus 25 is electrically connected to a positive electrode of the high-voltage power source 26. The film provided on the collection sheet 12 is electrically connected to a negative electrode of the high-voltage power source 26.

In the case where the electrostatic stylus 25 is electrically connected to the positive electrode of the high-voltage power source 26, the film provided on the collection sheet 12 may be connected to a ground potential. Alternatively, the electrostatic stylus 25 may be electrically connected to the negative electrode of the high-voltage power source 26 and the film provided on the collection sheet 12 may be electrically connected to the positive electrode of the high-voltage power source 26.

During the collection step performed by the collection unit 21, the air outside the device is introduced to the collection sheet 12 through the collection barrel 27 due to driving of the fan 23. In so doing, by generating the potential difference between the electrostatic stylus 25 and the collection sheet 12 by using the high-voltage power source 26, the airborne particles are positively charged around the electrostatic stylus 25. The positively charged particles are moved to the collection sheet 12 by electrostatic forces and attracted to the electrically conductive film, thereby being collected on the collection sheet 12.

Thus, in the present variant, the particles are collected on the collection sheet 12 by electrostatic collection that utilizes the electrostatic forces. In this case, the particles can be reliably held on the collection sheet 12 during detection of the particles, and after the particles have been detected, the particles can be easily removed from the collection sheet 12.

Furthermore, by using the needle-shaped electrostatic stylus 25 as the discharge electrode, the charged particles can be attracted to a very narrow region of the surface of the collection sheet 12 facing the electrostatic stylus 25, the region corresponding to a region irradiated with a light emitting element. Thus, in the fluorescence detection step, which will be described later, microorganisms having been attracted can be efficiently detected.

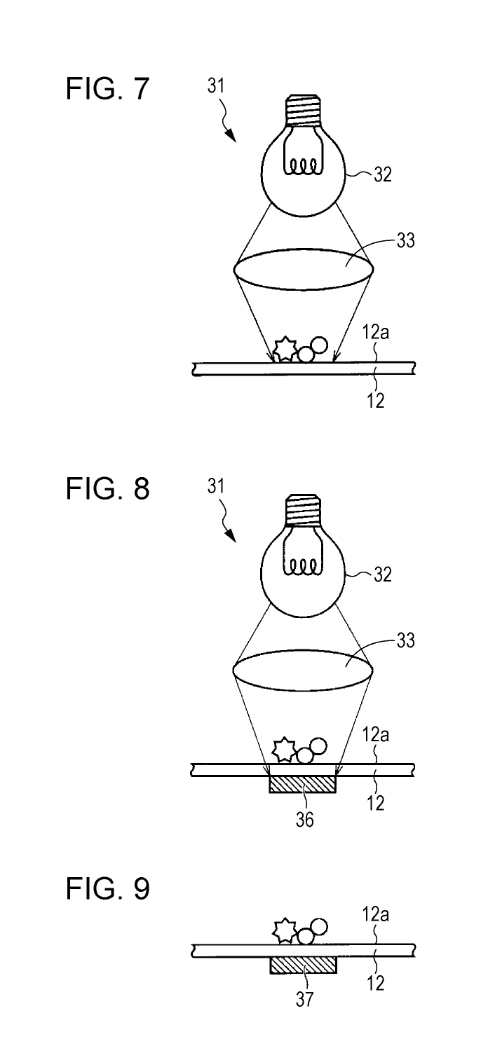

FIG. 7 is a side view illustrating the heating unit provided in the particle detection device illustrated in FIG. 3. Referring to FIG. 7, the heating unit 31 heats the particles collected on the collection sheet 12 by the collection unit 21.

The heating unit 31 includes a lamp 32 and a condensing lens 33. The lamp 32 is provided as a light source that emits light. The lamp 32 faces the adhesive surface 12a of the collection sheet 12. The lamp 32 uses a halogen lamp, a far-infrared radiation heater, a laser, a xenon lamp, or the like. The condensing lens 33 concentrates light emitted from the lamp 32 onto the adhesive surface 12a of the collection sheet 12. The condensing lens 33 is disposed between the lamp 32 and the collection sheet 12.

The collection sheet 12 is preferably formed of a light absorbing member that can absorb the light emitted from the lamp 32.

During the heating step performed by the heating unit 31, the light emitted from the lamp 32 is concentrated on the adhesive surface 12a of the collection sheet 12 through the condensing lens 33. This causes the collection sheet 12 to be heated. The heat is transferred from the heated collection sheet 12 to the particles, thereby the particles collected on the collection sheet 12 are heated. In the present embodiment, by concentrating the light, the collection sheet 12 can be locally heated. This can further reduce a time period to heat the particles and reduce power consumption of the lamp 32.

FIG. 8 is a side view illustrating a first variant of the heating unit illustrated in FIG. 7. Referring to FIG. 8, the present variant further includes a light absorbing member 36. The light absorbing member 36 is formed of a material that absorbs the light emitted from the lamp 32 at a high light absorption ratio. The light absorbing member 36 is provided so as to be in contact with a rear surface of the collection sheet 12 disposed on a rear side of the adhesive surface 12a.

The collection sheet 12 is formed of a light-transmitting member that allows the light emitted from the lamp 32 to be transmitted therethrough.

In such a structure, the light absorbing member 36 absorbs the light emitted from the lamp 32, and accordingly, is heated during the heating step performed by the heating unit 31. The heat is transferred from the heated light absorbing member 36 and the heated collection sheet 12 to the particles collected on the collection sheet 12, thereby the particles are heated.

FIG. 9 is a side view illustrating a second variant of the heating unit illustrated in FIG. 7. Referring to FIG. 9, the present variant includes a ceramic heater 37 serving as a heat generating unit instead of the lamp 32 and the condensing lens 33 illustrated in FIG. 7. The ceramic heater 37 is provided so as to be in contact with the rear surface of the collection sheet 12 disposed on the rear side of the adhesive surface 12a.

The collection sheet 12 preferably uses a metal material through which heat generated by the ceramic heater 37 is easily transferred (for example, copper) or a thin resin material (for example, polyimide) having a small thickness (equal to or less than 100 μm).

In such a structure, the collection sheet 12 is heated by the heat generated by the ceramic heater 37 during the heating step performed by the heating unit 31. The heat is transferred from the heated collection sheet 12 to the particles, thereby the particles are heated.

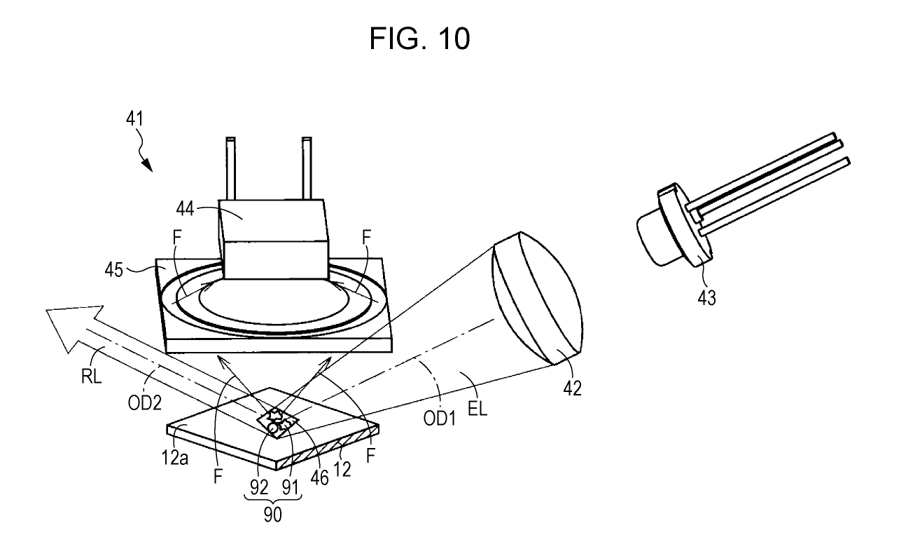

FIG. 10 is a perspective view illustrating the fluorescence detection unit provided in the particle detection device illustrated in FIG. 3. Referring to FIG. 10, the fluorescence detection unit 41 detects the fluorescence emitted from the particles which are collected on the collection sheet 12. In the present embodiment, the fluorescence detection unit 41 detects the fluorescence emitted from the particles before and after heating performed by the heating unit 31.

The fluorescence detection unit 41 includes a light emitting element 43, a condensing lens 42, a light receiving element 44, and a Fresnel lens 45. The light emitting element 43 and the condensing lens 42 are provided as parts of an excitation optical system that irradiates the adhesive surface 12a of the collection sheet 12 with excitation light. The light receiving element 44 and the Fresnel lens 45 are provided as parts of a light receiving optical system that receives the fluorescence emitted from the particles 90 when the particles 90 are irradiated with excitation light from the excitation optical system.

The light emitting element 43 uses, for example, a semiconductor laser element that emits blue laser light at a wavelength of 405 nm. The light emitting element 43 may instead use an LED (light emitting diode). The wavelength of light emitted from the light emitting element 43 may be in an ultraviolet range or a visible range as long as the light can excite biological particles and cause the biological particles to emit the fluorescence. The light receiving element 44 uses, for example, a photodiode or an image sensor.

Excitation light EL emitted by the light emitting element 43 is concentrated while passing through the condensing lens 42. An excitation light irradiation region 46 on the adhesive surface 12a of the collection sheet 12 is irradiated with the excitation light EL having been thus condensed. The excitation light EL is obliquely incident upon the adhesive surface 12a of the collection sheet 12. In FIG. 10, a one-dot chain line denoted by sign OD1 indicates a light beam direction of the excitation light EL. Here, the light beam direction refers to a direction in which light beam components of light (excitation light EL in this case) travel. The light beam direction OD1 of the excitation light EL can also be referred to as an optical axis of the excitation optical system.

Light resulting from regular reflection of the excitation light EL at the adhesive surface 12a of the collection sheet 12 forms reflected light RL. In FIG. 10, a one-dot chain line denoted by sign OD2 indicates a light beam direction of the reflected light RL. Since the excitation light EL is obliquely incident upon the adhesive surface 12a of the collection sheet 12, the reflected light RL that undergoes regular reflection at the adhesive surface 12a is also reflected obliquely relative to the adhesive surface 12a.

The particles 90 are collected in the excitation light irradiation region 46. The particles 90 include the biological particles 91 such as microorganisms and the dust 92 such as lint of chemical fiber. Arrows denoted by sign F in FIG. 10 indicate fluorescence emitted from the particles 90. The fluorescence F is omnidirectionally emitted from parts of surfaces of the particles 90 irradiated with the excitation light EL. The fluorescence F traveling toward the light receiving optical system is concentrated while passing through the Fresnel lens 45 and received by the light receiving element 44. By using the Fresnel lens 45 as a condensing lens to concentrate the fluorescence F, the thickness of the condensing lens can be reduced. Thus, the size and weight of the particle detection device 10 can be reduced.

When the area to be measured is large, the adhesive surface 12a may be entirely measured by scanning the optical system or the collection sheet 12. Alternatively, as illustrated in FIG. 3, the number of particles that emit the fluorescence may be counted by picking up an image of the fluorescence with an image pickup element 47 such as a CCD (charge coupled device) or a CMOS (complementary metal oxide semiconductor) and counting the number of bright points.

Referring to FIG. 3, the particle detection device 10 according to the present embodiment further includes a movement mechanism 51. The movement mechanism 51 moves the collection sheet 12 in the particle detection device 10. The movement mechanism 51 moves the collection sheet 12 between the collection position 81, the heating/cooling position 82, and the fluorescence detection position 83.

The movement mechanism 51 includes the sheet supply drum 52, the sheet reception drum 53, and a motor (not illustrated) that rotates these drums. The collection sheet 12 is hung between the sheet supply drum 52 and the sheet reception drum 53. Both ends of the collection sheet 12 are respectively wounded around the sheet supply drum 52 and the sheet reception drum 53. When the sheet supply drum 52 and the sheet reception drum 53 are rotated by driving the motor (not illustrated), the particles collected on the collection sheet 12 are moved between the collection position 81, the heating/cooling position 82, and the fluorescence detection position 83.

According to the present invention, the collection sheet 12 is not necessarily contained in the form of a roll. For example, the collection sheet 12 folded into a plurality of layers may be contained.

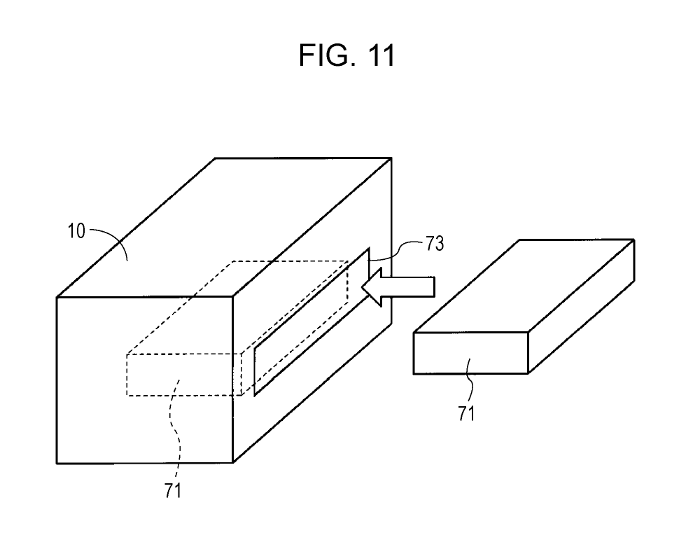

FIG. 11 is a perspective view for describing a method of replacing the collection sheet illustrated in FIG. 3. Referring to FIG. 11, the particle detection device 10 according to the present embodiment further includes a sheet cassette 71 serving as a housing.

The sheet cassette 71 has a housing shape that allows the sheet supply drum 52 or the sheet reception drum 53 to be contained therein. The collection sheet 12 wound into a roll is contained in the sheet cassette 71. The particle detection device 10 includes two sheet cassettes 71. The sheet supply drum 52 is contained in one of the sheet cassettes 71 and the sheet reception drum 53 is contained in the other sheet cassette 71. The sheet cassette 71 can be detached from or attached to the particle detection device 10 by opening a lid 73.

The collection sheet 12 has a sheet length sufficient to perform measurement a plurality of times. The collection sheet 12 having been used in measurement is rolled up on the sheet reception drum 53 so as to be collected. When measurement has been performed a predetermined number of times, the sheet cassettes 71 are replaced so that the sheet supply drum 52 around which a new collection sheet 12 is wound is attached to the device and the sheet reception drum 53 around which the collection sheet 12 having been used in the measurement is wound is removed from the device. In this case, the collection sheet 12 having been used in the measurement and on which the particles are attracted is wound into a roll. This prevents the particles from being removed, and accordingly, contamination of the device with the particles can be prevented. Thus, safe and easy replacement of the collection sheet 12 can be realized.

With the sheet cassettes 71, the particles can be easily continuously measured without maintenance.

Next, the steps of a method of particle detection with the particle detection device 10 according to the present embodiment are described.

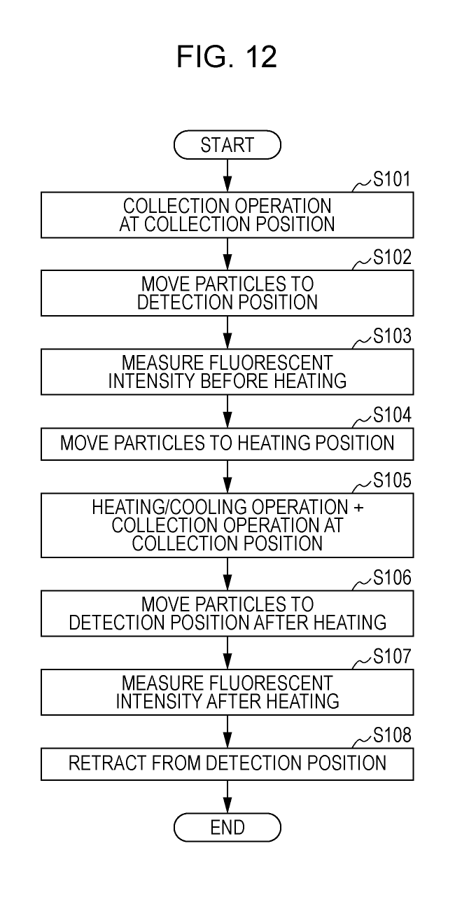

FIG. 12 is a flowchart illustrating a flow of operations of the particle detection device illustrated in FIG. 3. Referring to FIG. 12, the collection step for the particles is initially performed at the collection position 81 (S101). In this step, by driving the fan 23, the air outside the device is introduced into the collection barrel 22. The air having been taken into the collection barrel 22 is blown to the adhesive surface 12a of the collection sheet 12, thereby the airborne particles are collected on the collection sheet 12.

Next, the particles collected on the collection sheet 12 are moved from the collection position 81 to the fluorescence detection position 83 (S102). Next, the fluorescence detection unit 41 irradiates the particles with the excitation light, and the fluorescence emitted from the particles due to the irradiation of the particles with the excitation light is received. Thus, the fluorescent intensity of the particles before heating is measured (S103).

Next, the particles having undergone the measurement of the fluorescent intensity before heating are moved from the fluorescence detection position 83 to the heating/cooling position 82 (S104). Next, the heating unit 31 irradiates the particles with light so as to heat the particles. After that, the irradiation of the particles with the light is stopped so as to cool the particles. In the present embodiment, by driving the fan 23 at the collection position 81 in parallel with the heating/cooling step for the particles, particles for the next measurement are collected on the collection sheet 12 (S105).

Next, the particles having undergone the heating/cooling step are moved from the heating/cooling position 82 to the fluorescence detection position 83 (S106). In this step, the particles for the next measurement are moved from the collection position 81 to the heating/cooling position 82. Next, the fluorescence detection unit 41 irradiates the particles with the excitation light, and the fluorescence emitted from the particles due to the irradiation of the particles with the excitation light is received. Thus, the fluorescent intensity of the particles after heating is measured (S107).

Next, the particles having undergone the measurement of the fluorescent intensity after heating are collected on the sheet reception drum 53 from the fluorescence detection position 83 (S108). At the same time as this, the particles for the next measurement prepared at the heating/cooling position 82 are moved to the fluorescence detection position 83, and the fluorescent detection step before heating is performed.

By iterating the above-described steps, the biological particles can be continuously detected.

According to the present embodiment, the collection sheet 12 having low heat capacity is used so that the airborne particles are collected. Thus, heating and cooling time periods in the above-described heating/cooling step are reduced, and power consumed by the lamp 32 and the ceramic heater 37 can be reduced. Furthermore, since the particles can be heated by the heating device, the size and the cost of which are further reduced, the cost and the size of the particle detection device can be reduced.

Furthermore, according to the present embodiment, the collection step for the particles for the next measurement is performed in parallel with the heating/cooling step. Thus, a time period taken for continuous measurement can be further reduced. Here, the timing at which the particles for the next measurement are collected is not limited to the above-described heating/cooling step. The particles for the next measurement may instead be collected when, for example, the fluorescent intensity is measured after heating (S107).

According to the present embodiment, by measuring the difference in the amount of fluorescence before and after heating, an effect on the fluorescence produced by the particles other than the biological particles is canceled out. However, the present invention is not limited to this. For example, the fluorescence from biological particles may be identified as follows: only a state in which the fluorescence is increased after heating is picked up by the image pickup element, a threshold brightness value is set, and fluorescent points of brightness values equal to or more than a certain brightness value are determined as those of the biological particles.

The structure of the particle detection device 10 according to the embodiment of the present invention having been described above is summarized as follows: that is, the particle detection device 10 according to the present embodiment detects biological particles. The particle detection device 10 includes the collection sheet 12, the collection unit 21, the heating unit 31, the fluorescence detection unit 41, and the movement mechanism 51. The collection sheet 12 serves as the sheet-shaped member. The collection unit 21 introduces airborne particles into the device so that the airborne particles are collected on the collection sheet 12. The heating unit 31 heats the particles collected on the collection sheet 12 so as to increase the fluorescence emitted from the particles. The fluorescence detection unit 41 detects the fluorescence emitted from the particles which are collected on the collection sheet 12. The movement mechanism 51 moves the collection sheet 12.

With the particle detection device 10 according to the embodiment of the present invention, which has the above-described structure and in which the collection sheet 12 having small heat capacity is used for collecting the airborne particles, a measurement time period and the cost of measurement can be reduced.

The particle detection device 10 according to the present embodiment may be used as a standalone device for detecting biological particles or may be incorporated into a home appliance such as an air purifier, an air conditioner, a humidifier, a dehumidifier, a cleaner, a refrigerator, or a television set.

It should be understood that the embodiment disclosed herein is exemplary and not limiting in any sense. It is intended that the scope of the present invention is defined not by the above description but by the scope of the claims, and any modification within the meaning and the scope equivalent to the scope of the claims is included in the scope of the present invention.

### INDUSTRIAL APPLICABILITY

The present invention is mainly utilized as a device that detects biological particles such as pollen, microorganisms, and molds.

### REFERENCE SIGNS LIST

10 particle detection device, 12 collection sheet, 12a adhesive surface, 13 base material, 14 adhesive, 21 collection unit, 22, 27 collection barrel, 22p suction portion, 22q discharge portion, 23 fan, 25 electrostatic stylus, 26 high-voltage power source, 31 heating unit, 32 lamp, 33, 42 condensing lens, 36 light absorbing member, 37 ceramic heater, 41 fluorescence detection unit, 43 light emitting element, 44 light receiving element, 45 Fresnel lens, 46 excitation light irradiation region, 47 image pickup element, 51 movement mechanism, 52 sheet supply drum, 53 sheet reception drum, 71 sheet cassette, 73 lid, 81 collection position, 82 heating/cooling position, 83 fluorescence detection position, 90, 91 particle, 92 dust.

1. A particle detection device that detects a biological particle, the device comprising:
a sheet-shaped member;
a collection unit that introduces an airborne particle into the device so that the airborne particle is collected on the sheet-shaped member;
a heating unit that heats the particle collected on the sheet-shaped member so as to increase fluorescence emitted from the particle;
a fluorescence detection unit that detects the fluorescence emitted from the particle which is collected on the sheet-shaped member; and
a movement mechanism that moves the sheet-shaped member.

2. The particle detection device according to claim 1,
wherein the sheet-shaped member includes an adhesive surface, and
wherein the collection unit blows the airborne particle having been introduced into the device to the sheet-shaped member so that the particle is collected on the adhesive surface.

3. The particle detection device according to claim 1,
wherein the movement mechanism moves the sheet-shaped member between a first position, at which the particle is collected on the sheet-shaped member by the collection unit, a second position, at which the particle is heated by the heating unit, and a third position, at which the fluorescence is detected by the fluorescence detection unit.

4. The particle detection device according to claim 1,
wherein the sheet-shaped member continuously extends in a sheet shape through a first position, at which the particle is collected on the sheet-shaped member by the collection unit, a second position, at which the particle is heated by the heating unit, and a third position, at which the fluorescence is detected by the fluorescence detection unit.

5. The particle detection device according to claim 1,
wherein the heating unit includes a light source that emits light toward the particle.

6. The particle detection device according to claim 1,
wherein the movement mechanism includes a sheet supply unit that supplies the sheet-shaped member to the collection unit and a sheet reception unit that collects the sheet-shaped member from the fluorescence detection unit.

7. The particle detection device according to claim 1, the device further comprising:
a housing that contains the sheet-shaped member wound into a roll and that is detachably attached to the device.

8. The particle detection device according to claim 1,
wherein the biological particle is detected from a difference between an amount of the fluorescence detected from the particle before the particle is heated by the heating unit and an amount of the fluorescence detected from the particle after the particle has been heated by the heating unit.
